(19) United States
(12) Patent Application Publication
(10) Pub. No.: US 2017/0059869 A1
(43) Pub. Date: Mar. 2, 2017

(54) OPTICAL SYSTEM FOR HEAD MOUNT DISPLAY

(71) Applicant: Jun Hee LEE, Seoul (KR)

(72) Inventor: Jun Hee LEE, Seoul (KR)

(21) Appl. No.: 15/351,940

(22) Filed: Nov. 15, 2016

Related U.S. Application Data
(63) Continuation of application No. PCT/KR2015/004924, filed on May 15, 2015.

(30) Foreign Application Priority Data
May 15, 2014 (KR) 10-2014-0058293

(51) Int. Cl. G02B 27/01; G02B 27/22; G02C 11/00; G02B 27/26

(52) U.S. Cl. CPC G02B 27/0172; G02B 27/26; G02B 27/2264; G02C 11/10; G02B 2027/0178; G02B 2027/0134

(57) ABSTRACT

Disclosed is an optical system for a head mount display, including at least a display unit that is provided on an inner surface of a leg area of an eyeglass frame to provide virtual screen light, an optical path adjusting unit that is provided on a nose support area of the eyeglass frame to convert a direction of the virtual screen light delivered from the display unit by refracting or reflecting the virtual screen light, and an optical coupling unit that is provided in an interior of an eyeglass lens or at a location that is adjacent to the eyeglass lens to combine a virtual screen and a reality screen that is introduced from the outside and deliver the combined screen to the eyes of a wearer.

### CROSS-REFERENCE TO RELATED APPLICATIONS

The present application is a continuation of International Patent Application No. PCT/KR2015/004924, filed May 15, 2015, which is based upon and claims the benefit of priority to Korea Patent Application No. 10-2014-0058293, filed on May 15, 2014. The disclosures of the above-listed applications are hereby incorporated by reference herein in their entirety.

### BACKGROUND

Embodiments of the inventive concept described herein relate to an optical system for a head mount display.

An optical system for a head mount display refers to an optical system for implementing a device configured to allow a user to view a 3D image through a liquid crystal screen that approaches the two eyes of the user.

Korean Patent Application Publication No. 2014-0036351 (entitled “Compact See-through Display System” and published on Mar. 25, 2014 (Google Inc.)) discloses a configuration of an existing optical system for a head mount display. The existing optical system for a head mount display includes a window lens that receives external light, a beam splitter that is inclined by 45 degrees with respect to external light, an optical pipe through which external light reflected by the beam splitter and light of a virtual screen that exits from a display panel pass, a near image former that merges the light of the display panel and the light of a light source, and a near beam splitter that reflects the light merged by the near image former. The display panel includes a liquid crystal on silicon (LCOS) using a liquid crystal and an organic light emitting display on silicon (OLEDoS) using an organic element, and the LCOS requires a light source as it cannot directly emit light.

A virtual screen formed by merging the light of the display panel and the light of the light source with the near image former is reflected by the near beam splitter, passes through the optical pipe, enters an image former, is merged with external light (a reality screen) reflected by the beam splitter, is reflected by the beam splitter again, and enters the eyes of the user.

With this configuration, the external light (the reality screen) and the light (the virtual screen) of the display panel are merged by the image former to form an augmented reality screen in which the virtual screen and the reality screen are merged, which is in turn sent to the eyes of the user, allowing the user to feel both the virtual screen and the reality screen.

The conventional optical system for a head mount display has a large volume due to the near beam splitter around the display and the beam splitter around the field of view of the user as a whole, and the optical pipe that connects the two elements also has a large volume, which causes an inconvenience problem.

Further, the conventional optical system for a head mount display has to always provide a fixed screen and a fixed field of view and to actually move the eyes of the wearer to secure a screen and a focus, which also causes an inconvenience problem.

Further, according to the conventional optical system for a head mount display, because the screen that has exited from the display part for a right eye (or a left eye) passes the configurations without charging the direction thereof to enter the right eye (or the left eye) and the configurations are fixed within the optical pipe, a specific volume or more has to be secured so that a length of an optical path that is necessary for implementing an augmented reality may be secured.

Further, according to the conventional optical system for a head mount display, because a focus cannot be secured if the length of the optical pipe is reduced to reduce the volume thereof and the length of the optical system has to be about two times as larger as a general distance between the eyes of the user and the eyeglass lens, the mobility of the optical system cannot be secured. For example, the focus may be disturbed even though the optical system is shaken to a degree.

Further, according to the conventional optical system for a head mount display, another person may feel as if the user wears a special device due to the protruding display unit and the larger volume of the optical system when the user wears the optical system.

### SUMMARY

Embodiments of the inventive concept provide an optical system for a head mount display that allows another person to feel as if a user wore general eyeglasses as a volume of the optical system is reduced by converting a direction of a screen that has exited from a display unit.

Embodiments of the inventive concept also provide an optical system for a head mount display that allows a wearer to feel a 3D augmented reality by providing a 3D virtual screen.

In accordance with an aspect of the inventive concept, there is provided an optical system for a head mount display, including a display unit that is provided on an inner surface of a leg area of an eyeglass frame to provide virtual screen light, an optical path adjusting unit that is provided on a nose support area of the eyeglass frame to convert a direction of the virtual screen light delivered from the display unit by refracting or reflecting the virtual screen light, and an optical coupling unit that is provided in an interior of an eyeglass lens or at a location that is adjacent to the eyeglass lens to combine a virtual screen and a reality screen that is introduced from the outside and deliver the combined screen to the eyes of a wearer, wherein the optical path adjusting unit inputs the virtual screen light, an optical path of which has been converted, to an interior of the optical coupling unit at an angle within a specific range.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view illustrating a connection relationship of an optical system for a head mount display according to an embodiment of the inventive concept;

FIG. 2 is a plan view illustrating the optical system for a head mount display according to the embodiment of the inventive concept;

FIG. 3 is a front view illustrating the optical system for a head mount display according to the embodiment of the inventive concept;

FIG. 4 is a view illustrating an example of an optical path adjusting unit according to the embodiment of the inventive concept;

FIG. 5 is a view illustrating an example of a divided reflective surface including a first reflective surface and a second reflective surface according to the embodiment of the inventive concept;

FIG. 6 is a view illustrating an example in which a coupling lens module is a polarized curved surface mirror according to the embodiment of the inventive concept;

FIG. 7 is a view illustrating an example in which the coupling lens module is a TIR free curved surface prism according to the embodiment of the inventive concept;

FIG. 8 is a view illustrating an example of an optical system for a head mount display in which a display unit, an optical path adjusting unit, and an optical coupling unit may be separated from or coupled to an eyeglass frame;

FIG. 9 is a view illustrating an example of a process in which virtual screen light that travels in a guide lens comes within the field of vision of a wearer by using a plurality of polarized lenses; and

FIG. 10 is a view illustrating an example in which the optical system for a head mount display is provided within a general eyeglass shape according to the embodiment of the inventive concept.

### DETAILED DESCRIPTION

Hereinafter, exemplary embodiments of the inventive concept will be described in detail with reference to the accompanying drawings. The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept is provided to make the disclosure of the inventive concept complete and fully inform those skilled in the art to which the inventive concept pertains of the scope of the inventive concept. The same reference numerals denote the same elements throughout the specification.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements.

In the specification, a virtual screen corresponds to a screen that is generated by an optical system for a head mount display. That is, virtual screen light refers to light corresponding to a virtual screen that is provided by an optical system for a head mount display. A reality screen refers to a screen that enters the eyes of a wearer from the outside. That is, the reality screen refers to an actual external image that is viewed by a wearer wearing eyeglasses including an optical system for a head mount display.

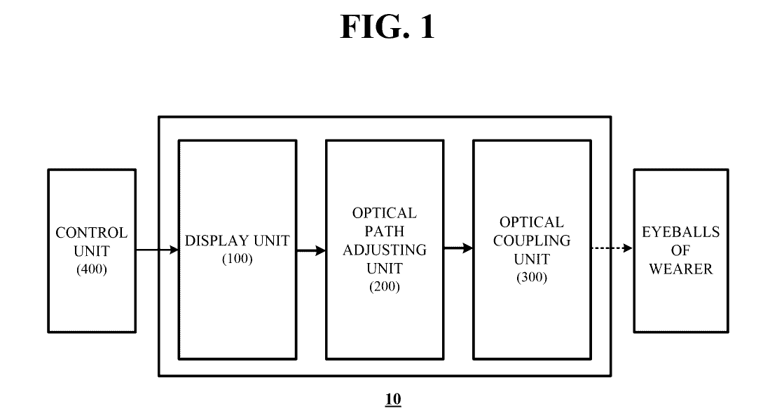

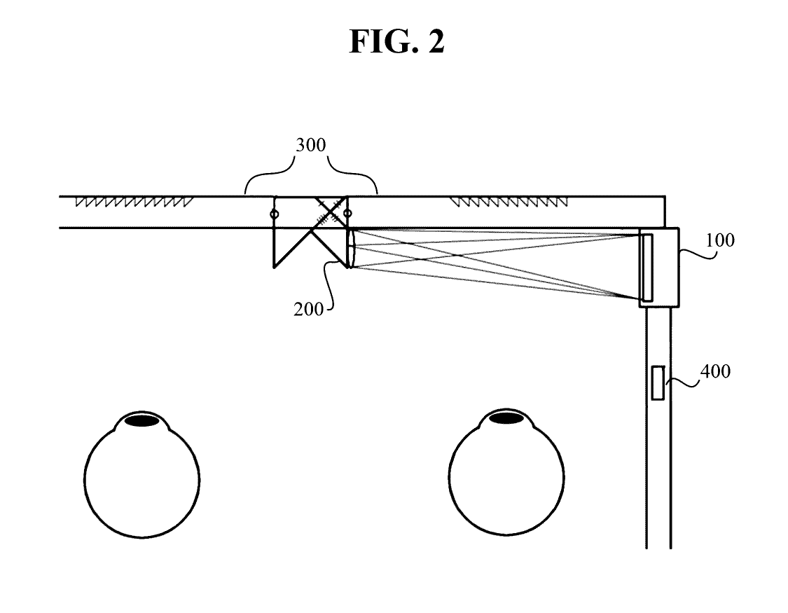

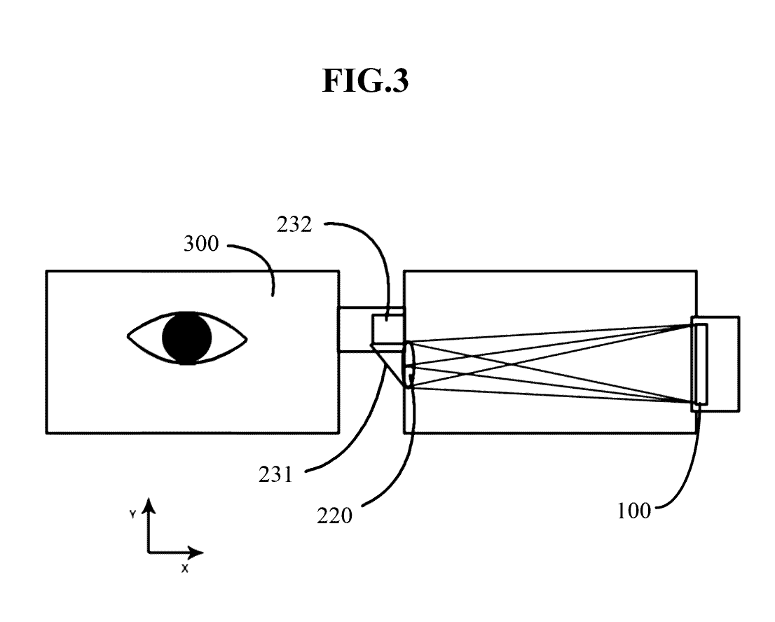

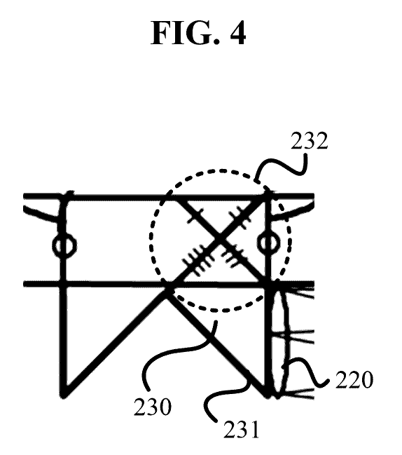

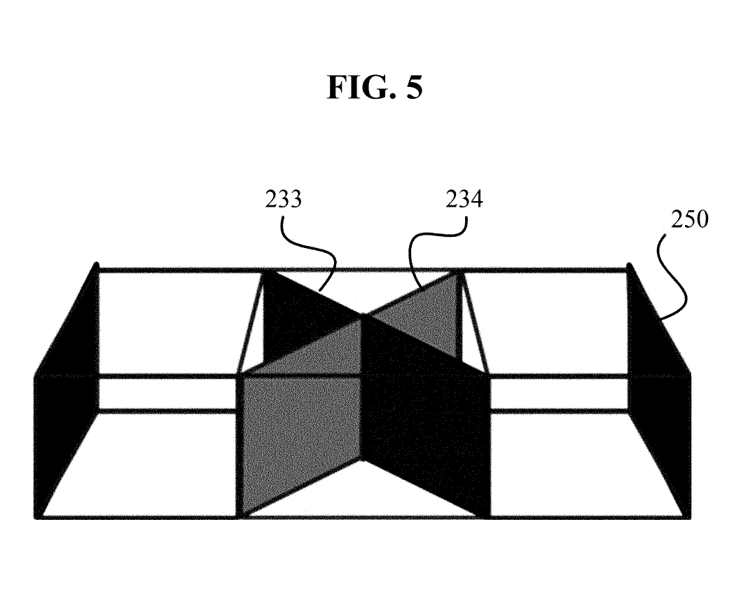

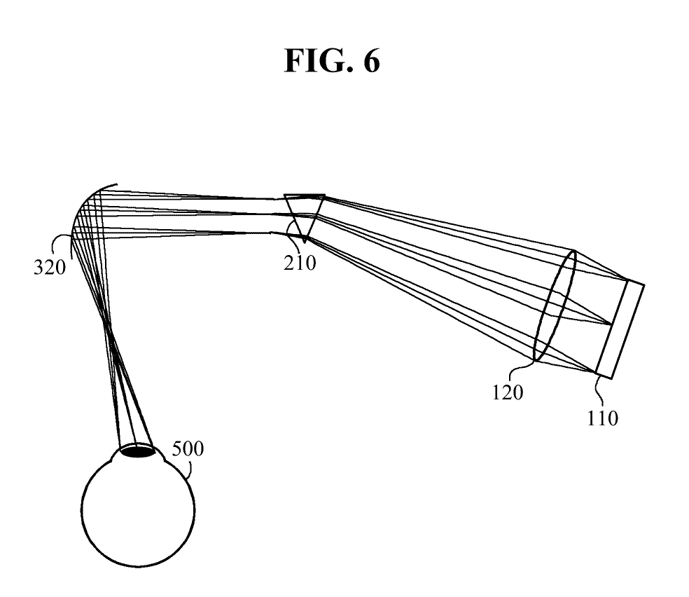

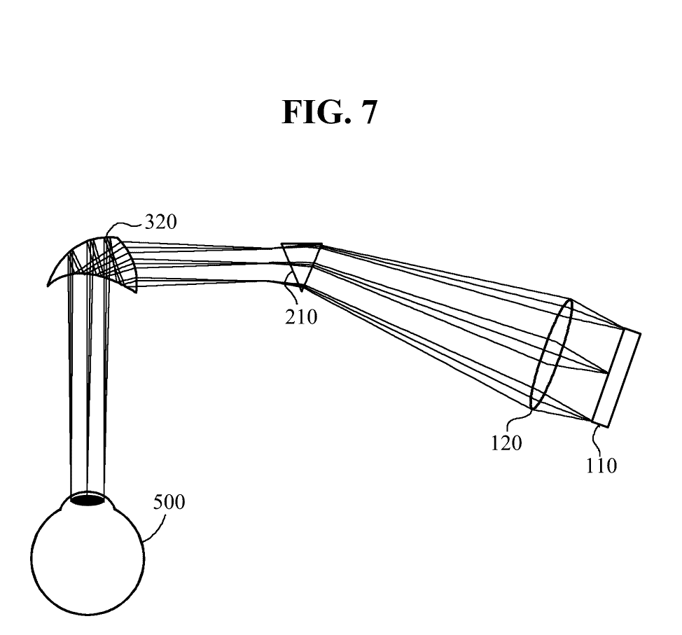

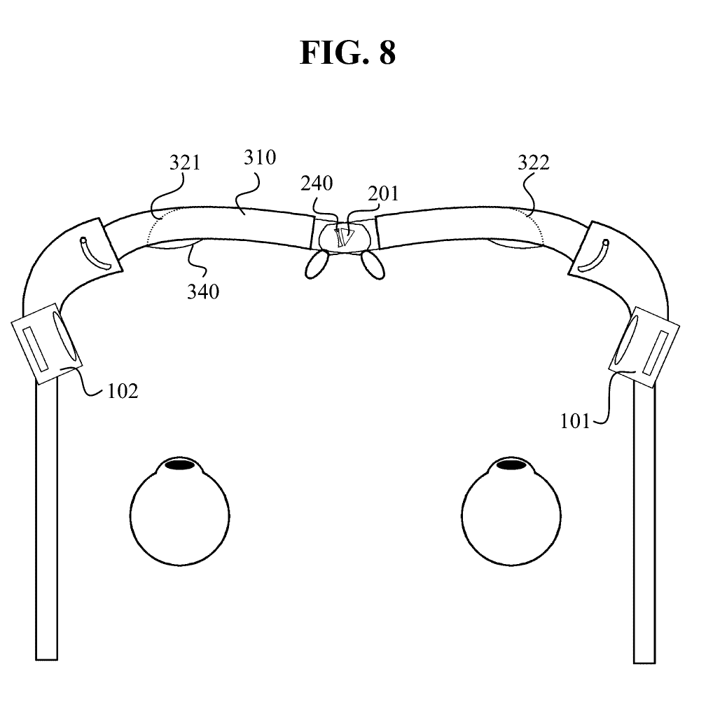

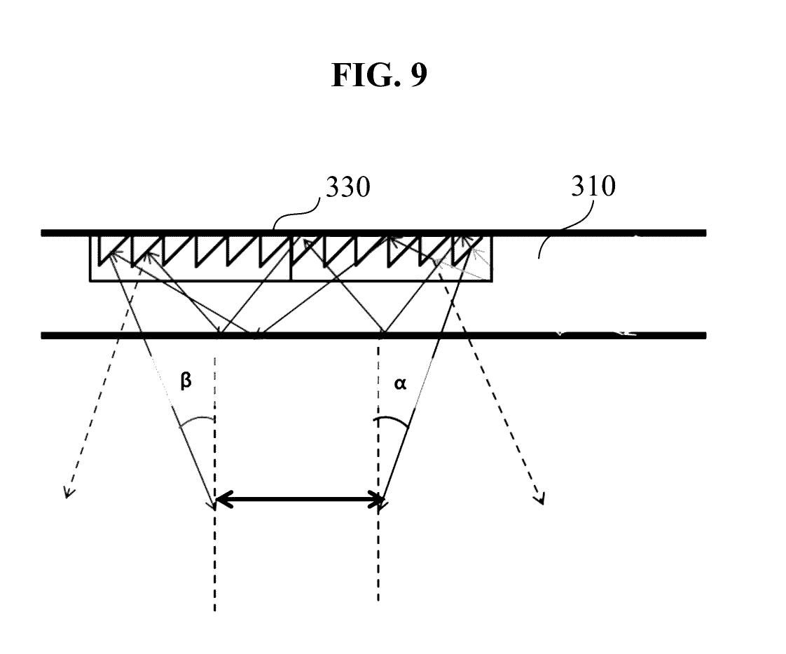

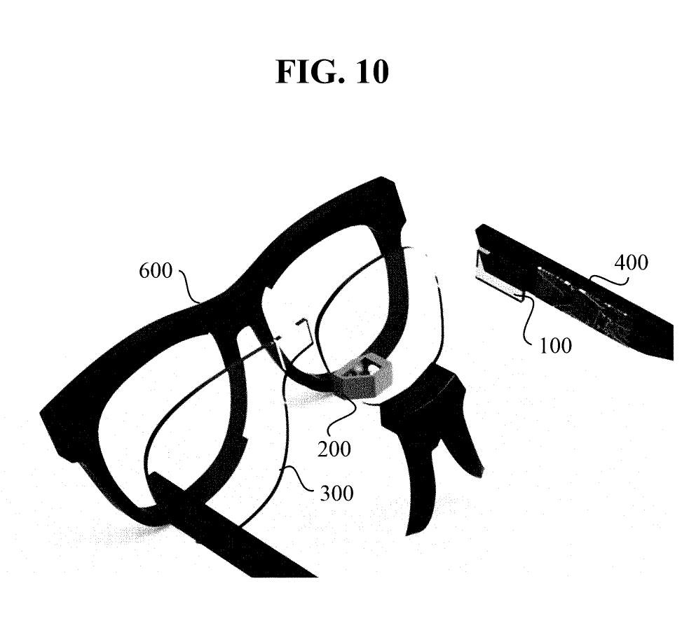

FIG. 1 is a view illustrating a connection relationship of an optical system 10 for a head mount display according to an embodiment of the inventive concept. FIG. 2 is a plan view illustrating the optical system 10 for a head mount display according to the embodiment of the inventive concept. FIG. 3 is a front view illustrating the optical system 10 for a head mount display according to the embodiment of the inventive concept. FIG. 4 is a view illustrating an example of an optical path adjusting unit 200 according to the embodiment of the inventive concept. FIG. 5 is a view illustrating an example of a divided reflective surface 232 including a first reflective surface 233 and a second reflective surface 234 according to the embodiment of the inventive concept. FIG. 6 is a view illustrating an example in which a coupling lens module 320 is a polarized curved surface mirror according to the embodiment of the inventive concept. FIG. 7 is a view illustrating an example in which the coupling lens module 320 is a TIR free curved surface prism according to the embodiment of the inventive concept. FIG. 8 is a view illustrating an example of an optical system 10 for a head mount display in which a display unit 100, an optical path adjusting unit 200, and an optical coupling unit 300 may be separated from or coupled to an eyeglass frame 600 according to the embodiment of the inventive concept. FIG. 9 is a view illustrating an example of a process in which virtual screen light that travels in a guide lens 310 comes within the field of vision of a wearer by using a plurality of polarized lenses 330 according to the embodiment of the inventive concept. FIG. 10 is a view illustrating an example in which the optical system 10 for a head mount display is provided within a general eyeglass shape according to the embodiment of the inventive concept.

FIGS. 1 to 10 illustrate an optical system 10 for a head mount display, a display unit 100, a display unit 101 for a left eye, a display unit 102 for a right eye, a display panel 110, a screen delivery lens 120, an optical path adjusting unit 200, an optical path adjusting unit 201 for a left eye, an adjustment prism 210, a convergence lens module 220, an optical path refraction module 230, a path conversion reflective surface 231, a divided reflective surface 232, a first reflective surface 233, a second reflective surface 234, a divergence lens module 240, a liquid crystal shutter 250, an optical coupling unit 300, a guide lens 310, a coupling lens module 320, a coupling lens module 321 for a left eye, a coupling lens module 322 for a right eye, a polarized lens 330, an imaging lens 340, a control unit 400, the eyes 500 of a wearer, and an eyeglass frame 600.

Hereinafter, the optical system 10 for a head mount display according to embodiments of the inventive concept will be described with reference to the drawings.

Referring to FIGS. 1 and 2, the optical system 10 for a head mount display according to an embodiment of the inventive concept includes a display unit 100, an optical path adjusting unit 200, and an optical coupling unit 300. Hereinafter, the configurations will be described in detail with reference to the drawings.

The display unit 100 performs a function of providing virtual screen light. The display unit 100 includes a display panel 110. The display panel 110 performs a function of generating a virtual screen.

Further, in some embodiments, as illustrated in FIGS. 6 and 7, the display unit 100 includes a screen delivery lens 120. The screen delivery lens 120 performs a function of converging the virtual screen light provided by the display panel 110 and providing the converged light to the optical path adjusting unit 200, which will be described below.

The screen delivery lens 120 is spaced apart from the display panel 110 by a specific gap. In more detail, it is preferable that the screen delivery lens 120 is arranged on the front side of the display panel 110 in parallel to the display panel 110 to be spaced apart from the display panel 110, preferably, by a gap of 9 mm to 15 mm and may be arranged in parallel to the display panel 110 to be perpendicular to the light exiting from the display panel 110. Here, the spacing gap is limited to the range because a size and an aberrance of the lens is large, which is not preferable, when the spacing gap is less than 9 mm and a volume reduction effect as compared with an existing product is excessively reduced, which is problematic and is not preferable, when the spacing gap exceeds 15 mm.

Further, in some embodiments, the screen delivery lens 120 has a refraction performance of converging virtual screen light to agree with a size of a hole for receiving virtual screen light of the optical path adjusting unit 200, which will be described below, or a size of the convergence lens module 220, which will be described below (that is, such that a size of an image of the virtual screen that reached the optical path adjusting unit 200 is not larger than the size of the hole or the size of the convergence lens module 220). For example, among the lenses that converge virtual screen light with a specific refractive index, a convex lens, a diffraction optical element (DOE) pattern lens, or a free curved surface prism lens may be used such that the size of the image of the virtual screen that reached the optical path adjusting unit 200 is not larger than the size of the convergence lens module 220. Further, the screen delivery lens 120 and 212 may prevent distortion of the virtual screen due to a spherical aberration through aspheric surface processing.

In some embodiments, as illustrated in FIG. 2, the display unit 100 is provided on an inner surface of a leg area of the eyeglass frame 600. For example, the display unit 100 is provided on an inner surface (that is, an inner surface of the leg area of the eyeglass frame 600, which is adjacent to the eyeglass lens) of the leg area of the eyeglass frame 600, which does not contact skin of the wearer. The optical system may have an external appearance of general eyeglasses by utilizing a dead interior space of the eyeglass frame 600 such that the outward volume of the eyeglass frame 600 may not increase. This allows the user not to feel inconvenience of wearing. Further, the volume of the head mount display device may be prevented from increasing.

The optical path adjusting unit 200 performs a function of converting a direction of the virtual screen light by refracting or reflecting the virtual screen light delivered from the display unit 100. That is, the optical path adjusting unit 200 functions to adjust the virtual screen delivered from the screen delivery lens 120 such that the virtual screen faces a suitable direction. The optical path adjusting unit 200 inputs the virtual screen light, of which an optical path is converted, to the interior of the optical coupling unit 300 at an angle with in a specific range. The optical path adjusting unit 200 may be arranged on the same optical axis as that of the display unit 100. In some embodiments, the optical path adjusting unit 200 is provided in a nose support area of the eyeglass frame 600.

The optical path adjusting unit 200 is implemented in various forms, and may deliver the virtual screen light delivered from the display unit 100 to the optical coupling unit 300. In some embodiments, as illustrated in FIGS. 6 and 7, the optical path adjusting unit 200 includes an adjustment prism 210. The adjustment prism 210 is situated in a nose support area of the eyeglass frame 600 on the same optical axis as that of the screen delivery lens 120, and coverts the direction of the virtual screen light delivered from the screen delivery lens 120 by refracting the virtual screen light. Here, it is preferable that the adjustment prism 210 be a reflective prism of a material having a small difference of refractive indexes for the wavelengths of light and may include a rectangular prism, a Pellin-Broca prism, and a Penta prism.

Further, in some embodiments, the adjustment prism 210 is implemented such that a location of the adjustment prism 210 is fixed but an angle of the adjustment prism 210 may be adjusted. In detail, it is preferable that the adjustment prism 210 be adjusted to an angle within 10 degrees to the left and right sides while an inner corner or surface of the adjustment prism 210 is taken as an axis. This structure is adapted to move the focus of the prism in correspondence to the locations of the eyes 500 of the wearer, and the adjusted angle range is set to allow the focus of the prism to be adjusted within the location ranges of the eyes 500 of persons. Further, in some embodiments, the adjustment prism 210 is implemented to have a size that includes an image of the virtual screen in proportion to the size of the image of the virtual screen, which is input.

In some embodiments, as illustrated in FIG. 3, the optical path adjusting unit 200 according to the embodiment of the inventive concept includes a convergence lens module 220 and an optical path refraction module 230.

The convergence lens module 220 is arranged to face the display unit 100, and may perform a function of converting the virtual screen light input from the display unit 100 to the interior of the optical path adjusting unit 200. That is, the convergence module 220 performs a function of converging the virtual screen light input from the display unit 100 to convert the paths of the light to the same, and delivering the converged virtual screen light to the optical path refraction module 230.

The optical path refraction module 230 has a specific refractive index to perform a function of adjusting the path of the virtual screen light through total reflection.

In some embodiments, as illustrated in FIG. 4, the optical path refraction module 230 includes a path conversion reflective surface 231 and a divided reflective surface 232. The path conversion reflective surface 231 performs a function of reflecting the virtual screen light input from one display 100 and converting the path of the virtual screen light. In some embodiments, the path conversion reflective surface 231 converts a direction of the virtual screen light to the direction of the divided reflective surface 232 through total reflection due to a difference of refractive indexes converged by the convergence lens module 220. That is, due to the difference between the densities of the interior of the optical path refraction module 230 and the exterior air while the path conversion reflective surface 231 is taken as a border, total reflection is made so that the path of the virtual screen light is converted. In some embodiments, the path conversion reflective surface 231 includes a coating layer that totally reflects the input virtual screen light to convert the path of the virtual screen path.

In some embodiments, when the divided reflective surface 232 includes a first reflective surface 233 and a second reflective surface 234 as will be described below, the path conversion reflective surface 231 is arranged at an angle by which the visual screen light delivered by the convergence lens module 220 is input to the first reflective surface 233 and the second reflective surface 234 at the same incidence angle.

In some embodiments, the divided reflective surface 232 performs a function of reflecting the totally reflected virtual screen light to deliver the reflected virtual screen light to the optical coupling unit 300 that is unidirectional or bidirectional. The divided reflective surface 232 includes different numbers of reflective surfaces based on the number of the optical coupling units 300. For example, when the optical coupling unit 300 is provided only in the left or right eyeball 500, the divided reflective surface 232 includes one reflective surface that may reflect virtual screen light towards a side on which the optical coupling unit 300 is provided. For example, when the optical system 10 for a head mount display includes an optical coupling unit 300 for a left eye and an optical coupling unit 300 for a right eye, the divided reflective surface 232 includes a first reflective surface 233 and a second reflective surface 234. The first reflective surface 233 and the second reflective surface 234 reflects the virtual screen light towards the optical coupling unit 300 for a left eye and the optical coupling unit 300 for a right eye, respectively, to deliver the reflected virtual screen light. That is, the first reflective surface 233 reflects the virtual screen light reflected by the path conversion reflective surface 231 to the optical coupling unit 300 for a left eye, and the second reflective surface 234 reflects the virtual screen light reflected by the path conversion reflective surface 232 to the optical coupling unit 300 for a right eye.

In some embodiments, as illustrated in FIG. 5, the divided reflective surface 232 is implemented such that the first reflective surface 233 and the second reflective surface 234 cross each other. The first reflective surface 233 and the second reflective surface 234 crosses each other such that the divided reflective surface 232 is divided into two areas (that is, a front area before they cross each other and a rear area after they cross each other).

In some embodiments, the first reflective surface 233 and the second reflective surface 234 includes different polarized coating layers. For example, the first reflective surface 233 and the second reflective surface 234 includes polarized coating layers that are perpendicular to each other, and passes polarized light (for example, S polarized light and P polarized light that are perpendicular to each other) that are perpendicular to each other. When the first reflective surface 233 has a S polarized light coating layer, the S polarized light of the virtual screen light that is input to the front area of the first reflective area 233 passes through the first reflective surface 233 and only the P polarized light of the virtual screen light is reflected and input to the optical coupling unit 300 for a left eye. The P polarized light of the virtual screen light, which is input to the front area of the second reflective surface 234, passes through the second reflective surface 234 to reach the rear area of the first reflective surface 233, and the P polarized light is reflected to be input to the optical coupling unit 300 for a left eye. Accordingly, only the P polarized light is input to the optical coupling unit 300 for a left eye by the divided reflective surface 232. In contrast, the second reflective surface 234 has a P polarized light coating layer, and the P polarized light of the virtual screen light, which is input to a front area of the second reflective surface 234, passes through the second reflective surface 234 and only the S polarized light is reflected to be input to the optical coupling unit 300 for a right eye. The S polarized light of the virtual screen light, which is input to the front area of the first reflective surface 233, passes through the first reflective surface 233 to reach the rear area of the second reflective surface 234, and the S polarized light is reflected to be input to the optical coupling unit 300 for a right eye. Accordingly, only the P polarized light is input to the optical coupling unit 300 for a left eye by the divided reflective surface 232. That is, as the vertical polarized light coating layer includes the first reflective surface 233 and the second reflective surface 234, the divided reflective surface 232 provides perpendicular polarized light to the optical coupling unit 300 for a left eye and the optical coupling unit 300 for a right eye.

Further, in some embodiments, the first reflective surface 233 and the second reflective surface 234 includes half mirrors. A half mirror refers to a lens (or a mirror) that reflects a portion of input light and transmits a portion of the input light. When the first reflective surface 233 and the second reflective surface 234 are coated with half mirrors having the same reflective index, uniform virtual screen light is introduced into the optical coupling unit 300 for a left eye and the optical coupling unit 300 for a right eye. For example, when the first reflective surface 233 and the second reflective surface 234 are implemented by half mirrors of which a reflective index and a transmissivity are 50%, 50% of the light is transmitted through the front areas of the first reflective surface 233 and the second reflective surface 234 and is delivered to the rear areas of the first reflective surface 233 and the second reflective surface 234. A half of 50% of the virtual screen light is reflected in the rear area and is delivered towards the optical coupling unit 300 for a left eye and the optical coupling unit 300 for a right eye. In the front areas of the first reflective surface 233 and the second reflective surface 234, 50% of the virtual screen light reflected by the first reflective surface 233 is input to the second reflective surface 234 and the second reflective surface 234 is deliver 25% of the whole virtual screen light to the optical coupling unit 300 for a left eye due to the transmissivity. In contrast, 50% of the virtual screen light reflected by the second reflective surface 234 is input to the first reflective surface 233, and the first reflective surface 233 delivers 25% of the whole virtual screen light to the optical coupling unit 300 for a right eye due to the transmissivity. Due to this, one ray of virtual screen light is delivered to the optical coupling unit 300 for a left eye and the optical coupling unit 300 for a right eye after being divided. Further, in some embodiments, only the front areas of the first reflective surface 233 and the second reflective surface 234 are implemented by half mirrors, and the rear areas thereof are implemented to totally reflect light.

Further, in some embodiments, as illustrated in FIG. 8, the optical path adjusting unit 200 further includes a divergence lens module 240. The divergence lens module 240 performs a function of enlarging the virtual screen light, the path of which is adjusted to the direction of the optical coupling unit by the optical path refraction module 230, at a predetermined magnification. That is, the divergence lens module 240 functions to form an image of a suitable magnification when the light, which passed through the adjustment prism 210 or the optical path refraction module 230 and was refracted, passes through the optical coupling unit 300 and the eyes 500 of the wearer. In some embodiments, the divergence lens module 240 employs a concave lens having a negative refraction performance, and is aspheric-surface processed to prevent distortion due to a spherical aberration. Further, in some embodiments, the divergence lens module is coupled to the adjustment prism 210 or the optical path refraction module 230 to be moved together when the angle thereof is adjusted, thereby enlarging the image of the virtual screen in the direction of the focus that agrees the wearer.

The optical coupling unit 300 performs a function of combining the virtual screen with a reality screen that is introduced from the outside to deliver the combined screen to the eyes 500 of the wearer. That is, the optical coupling unit 300 functions to combine the virtual screen and the reality screen to allow the wearer to feel an augmented reality screen, and to achieve this, the optical coupling unit 300 combines the reality screen with the virtual screen that is delivered after the direction thereof is converted by the optical path adjusting unit 200 and delivers the combined screen to the eyes 500 of the wearer.

In some embodiments, the optical coupling unit 300 is provided in the interior of the eyeglass lens or at a location that is adjacent to the eyeglass lens. That is, the optical coupling unit 300 is manufactured when the eyeglass lens is manufactured. Further, in some embodiments, the optical coupling unit 300 is separately manufactured to be situated adjacent to one side (for example, a surface of the eyeglass lens that is close to the eyeball 500) of the eyeglass lens.

In some embodiments, as illustrated in FIG. 8, the optical coupling unit 300 includes a guide lens 310 and a coupling lens module 320. The guide lens 310 functions as a passage through which the virtual screen light input from the optical path adjusting unit 200 travels. That is, the guide lens 310 induces the travel of the light delivered from the optical path adjusting unit 200. In some embodiments, the guide lens 310 accommodates the coupling lens module 320 therein.

Further, in some embodiments, the guide lens 310 is formed of a material (that is, the same medium as that of the guide lens 310) having the same refractive index as that of the divergence lens module 240. This allows the light to be delivered from the divergence lens module 240 to the guide lens 310 without refraction of light and then travel. Further, the guide lens 310 receives the virtual screen light from the optical path adjusting unit 200 at an angle within a specific range, and inputs the virtual screen light to the coupling lens module 320 through one or a plurality of total reflection processes. Further, the guide lens 310 allows the virtual screen light input from the optical path adjusting unit to travel straight to deliver the virtual screen light to the coupling lens module 320.

In some embodiments, the coupling lens module 320 refract or reflect the virtual screen light that has passed through the guide lens 310 to provide the virtual screen light in the direction of the eye balls 500. The coupling lens module 320 may be implemented in various manners. However, the coupling lens module 320 is not limited to the manner, which will be described below, and may be implemented in various manners that may provide the virtual screen light, which has passed the guide lens 310 to be input, in the direction of the eyeballs 500.

In some embodiments, as illustrated in FIGS. 6 and 7, the coupling lens module 320 employs a polarized curved surface mirror, a diffraction optical element (DOE) pattern lens, or a total internal reflection (TIR) free curved surface prism. For example, the polarized curved surface mirror is formed by combining a polarizing element and curved surface glass to allow only a portion of external reality screen light to pass through the polarized curved surface mirror after being polarized and enter the eyes 500 of the wearer, and the virtual screen, which has exited from the display panel, is polarized and reflected to enter the eyes 500 of the wearer as the virtual screen is input at a Brewster's angle. Further, the DOE pattern curved surface lens is a curved surface lens that is obtained by patterning a diffraction element at a micro meter scale, and allows the external reality screen light to enter the eyes 500 of the wearer via the spaces between lattices and also allows the virtual screen light diffracted by the diffraction element to enter the eyes 500 of the wearer. Further, the TIR free curved surface prism allows the virtual screen light that has exited from the optical path adjusting unit 200 to enter the eyes 500 of the wearer through internal total reflection after being input to the TIR free curved surface prism and allow the external reality screen light to enter the eyes 500 of the wearer after passing through the TIR free curved surface prism. In some embodiments, when the coupling lens module 320 is a polarized curved surface mirror, a diffraction optical element (DOE) pattern lens, or a total internal reflection (TIR) free curved surface prism, it is accommodated in the interior of the guide such that a concave surface thereof faces the optical path adjusting unit 200.

As illustrated in FIG. 9, another coupling lens module 320 according to an embodiment of the inventive concept may include a plurality of polarized lenses 330 including a polarized inclined surface that is inclined at a predetermined angle. In some embodiments, the polarized inclined surface is coupled to the guide lens 310 to face a side on which the virtual screen light is introduced. That is, the guide lens 310 includes a plurality of recesses corresponding the shapes of a plurality of polarized lenses 330 that allows the coupling lens module 320 to be coupled while the polarized inclined surface faces an introduction direction of the virtual screen light.

The plurality of polarized lenses 330 may be implemented in various forms. For example, as illustrated in FIG. 9, the inclined surfaces of the plurality of polarized lenses 330 are arranged in the direction of the optical path adjusting unit 200, polarized coating layers are formed on the inclined surfaces of the plurality of polarized lenses 330, and is implemented by a plurality of triangular prism polarized lenses 330 that are formed of the same medium as that of the guide lens 310. As the polarized lenses 330 are formed of the same medium as that of the guide lens 310, the virtual screen light is just reflected by the polarized coating layers while the virtual screen light travels through total reflection and is not refracted on a border surface of the guide lens 310 and the coupling lens module 320.

The inclination angles of the polarized inclined surfaces is determined based on the incidence angle range in which the virtual screen light is input from the optical path adjusting unit 200 to the guide lens 310. That is, only when the polarized inclined surfaces have inclination angles corresponding to the angle of the virtual screen light that is input to the guide lens 310 from the optical path adjusting unit 200, a specific ratio or more of the light reflected by the polarized reflective surfaces fall within a range of the field of view. Accordingly, the angles of the polarized inclined surfaces need to be determined to agree with the set incidence angle in the guide lens.

Further, in some embodiments, the polarized inclined surfaces have different polarized coating layers based on the locations thereof. The virtual screen light is input to the guide lens 310 from the optical path adjusting unit 200 at various incidence angles within a specific angle range, and is totally reflected along various paths. A portion of the virtual screen light that is totally reflected enter a suitable range of the field of view to form an image in the eyes 500 of the wearer. Because the virtual screen light has to travel to an opposite side of the guide lens 310 to form an image within a range of the field of view, only polarized light (for example, S polarized light) is reflected by the polarized coating layers and the remaining polarized light (for example, P polarized light) needs to continue to travel. Accordingly, the polarized lenses 330 may include polarized coating layers that are perpendicular to each other after being divided to front and rear parts with respect to a specific reference point.

Further, the polarized coating layers of the polarized inclined surfaces prevent unintended reflective light from being generated by the reflective surfaces while the virtual screen light passes through the inclined surfaces. That is, even when the virtual screen light is input to the inclined surfaces having the polarized coating layers of the same direction at an unintended angle after passing through the polarized lenses having the polarized coating layers of a specific direction and being totally reflected, it passes through the inclined surfaces without being reflected. This may prevent an illusion from being generated due to the reflection of the virtual screen light that is input in an unintended direction.

Further, in some embodiments, the polarized inclined surfaces are spaced apart from each other by a specific gap. When the polarized inclined surface are not arranged at a specific gap, the virtual screen light that was totally reflected after passing through the polarized inclined surfaces fails to travel to an opposite surface of the guide lens 310 but is reflected by the adjacent polarized inclined surface to generate reflective light of a unintended form.

Further, in some embodiments, coupling lens module 320 according to another embodiment of the inventive concept includes a plurality of half mirror lenses instead of a plurality of polarized lenses 330. That is, the inclined surfaces include half mirror lenses instead of polarized coating layers. Through this, the virtual screen light that passes after a portion of the virtual screen light is reflected may continue to be totally reflected. In the process, the virtual screen light that enters a range of the field of view of the wearer generates an image.

Further, in some embodiments, by differently applying the reflectivity of the inclined surfaces, the virtual screen light at various locations is input to the eyeballs 500 of the wearer at the same brightness. That is, when the inclined surfaces have the same reflectivity, the inclined surface of the coupling lens module 320, which is close to the optical path adjusting unit 200, reflects a large amount of virtual screen light and the inclined surface of the coupling lens module 320, which is far from the optical path adjusting unit 200, reflects a small amount of virtual screen light. Accordingly, in order that the virtual screen light of the same brightness enters the field of view of the wearer, the inclined surfaces have different reflectivity based on the locations thereof. For example, when the reflectivity of the first inclined surface is a, the virtual screen light of the same brightness enters the eyes 500 of the wearer while the reflectivity of the final inclined surface becoming β=α/(1−a).

Further, in some embodiments, as illustrated in FIG. 8, the optical coupling unit 300 further includes an imaging lens 340. The imaging lens 340 functions to finally adjust a final image, which is obtained by combining the reality screen image introduced from the outside and the virtual screen image provided by the display unit 100, according to an environment of the wearer. To achieve this, the imaging lens 340 is accommodated on a side surface of the eye 500 of the wearer in the interior of the guide lens 310, and adjusts a focal distance of the light that is output after being reflected by the coupling lens module 320.

Further, in some embodiments, the optical system 10 for a head mount display according to the embodiment of the inventive concept implement a virtual screen that is a 3D screen to provide the virtual screen. Hereinafter, various manners that may be applied to the optical system 10 for a head mount display according to the embodiment of the inventive concept will be described.

In some embodiments, a focal distance is adjusted by adjusting angles at which the vertical screen light is provided to the optical coupling unit 300 for a left eye and the optical coupling unit 300 for a right eye while the location of the optical path adjusting unit 200 is fixed. That is, the length of the optical path in the interior of the guide lens 310 may vary. For example, the number of total reflections may vary based on the incidence angles of the virtual screen light provided to the optical coupling unit 300 for a left eye and the optical coupling unit 300 for a right eye. Accordingly, a 3D screen may be implemented by generating a binocular parallax. This manner may be applied to both the case in which the display 100 is provided only on the left or right side and the case in which the displays 100 for the optical coupling unit 300 for a left eye and the optical coupling unit 300 for a right eye are prevent, respectively.

Further, in some embodiments, as illustrated in FIG. 5, the optical path adjusting unit 200 includes a plurality of liquid crystal shutters 250 in the directions of the optical coupling unit 300 for a left eye and the optical coupling unit 300 for a right eye. When the display unit 100 alternately provides virtual screen light for a right eye and virtual screen light for a left eye, the plurality of liquid crystal shutters 250 is opened and closed to correspond to the type of the virtual screen light provided by the display unit 100. That is, only the liquid crystal shutter 250 for a left side is opened when the virtual screen for a left eye is provided, and only the liquid crystal shutter 250 for a right eye may be opened when the virtual screen for a right eye is provided. For example, because the optical path refraction module 230 reflects the virtual screen light for a left eye and the virtual screen light for a right eye that are alternately input by one display unit 100 provided on one side of the leg area of the eyeglass frame 600 to opposite sides when the optical path adjusting unit 200 includes a path conversion reflective surface 231 and a division reflective surface 232 having a first reflective surface 233 and a second reflective surface 234, the virtual screens corresponding to the locations of the optical coupling units 300 is provided by adjusting opposite liquid crystal shutters 350 according to the timings at which the virtual screen for a left eye and the virtual screen for a right eye corresponding to the location of the optical coupling unit 300 are provided.

Further, in some embodiments, the display units 100 is arranged on inner surfaces of the leg areas of the eyeglass frame 600, respectively, and the optical path adjusting unit 200 includes an optical path adjusting unit 201 for a left eye and an optical path adjusting unit for a right eye having different optical path lengths. That is, the display unit 101 for a left eye that provides an image for a left eye and the display unit 102 for a right eye that provides an image for a right eye are provided, respectively, and the virtual screen light provided by the display units 100 has a parallax while passing through the optical path adjusting unit 201 for a left eye and the optical path adjusting unit 200 for a right eye having different optical path lengths. As the virtual screen light having a parallax is provided to the corresponding optical coupling unit 300, a 3D screen is implemented by generating a binocular parallax. For example, in a stereoscopic 3D screen implementing system utilizing the optical system for a head mount display according to the inventive concept, a direction of a virtual screen provided by the display 101 for a left eye installed on the right side is converted by the optical path adjusting unit 201 for a left eye situated at the center of the optical system, the virtual screen is delivered to the optical coupling unit for a right eye installed on the left side, and an augmented reality screen obtained by combining the virtual screen delivered from the optical coupling unit for a left eye and a reality screen is delivered to the left eye. Meanwhile, a direction of the virtual screen provided by the display unit 102 for a left eye installed on the left side is converted by the optical path adjusting unit 202 for a right eye situated at the center of the optical system, the virtual screen is delivered to the optical coupling unit for a right eye installed on the right side, and an augmented reality screen obtained by combining the virtual screen delivered by the optical coupling unit for a left eye and a reality screen is delivered to the right eye. The two virtual screens having a parallax that is delivered to the left eye and the right eye may allow the wearer to feel a three-dimensional feeling. Then, the optical path adjusting unit 201 for a left eye and the optical coupling unit for a left eye are connected to each other and the optical path adjusting unit for a right eye and the optical coupling unit for a right eye are connected to each other such that they correspond to the focuses of the left eye 500 and the right eye 500 based on a wearing environment of the wearer.

In some embodiments, when the optical system 10 for a head mount display according to the embodiment of the inventive concept is applied to the eyeglass as illustrated in FIG. 8, the display units 100 are installed to be situated in the leg areas of the eyeglass frame 600, and in detail, the display panel 110 and the screen delivery lens 120 are mounted on a separate frame and the separate frame is installed in the right leg of the eyeglass. That is, the display units 100 is manufactured as separate modules to be separated from or coupled to the eyeglass frame 600, and the locations of the display units 100 is adjusted according to the face of the user.

Further, in some embodiments, the optical path adjusting unit 200 is installed to be situated at the center of the body of the eyeglass, at which the nose support of the eyeglass is situated. For example, when the optical path adjusting unit 201 for a left eye and the optical path adjusting unit for a right eye are manufactured separately, they are coupled to the left nose support and the right nose support of the eyeglass frame 600. In detail, the optical path adjusting unit 201 for a left eye and the optical coupling unit for a left eye are mounted by a first frame that is manufactured separately and the first frame is coupled to the eyeglass frame 600 after the configurations are connected to each other (in more detail, the first frame is coupled to the eyeglass frame 600 such that it is situated from the center of the eyeglass frame 600 to the location of the eyeglass frame 600 before the left eye lens and the left eyeglass leg are coupled to each other). In more detail, the optical path adjusting unit 201 for a left eye is mounted to a socket for a left eye installed in the first frame, and the guide lens 310 of the optical coupling unit 300 for a left eye may be inserted into the first frame.

In some embodiments, the optical path adjusting unit 201 for a left eye and the optical path adjusting unit 200 for a right eye are provided in one frame to be coupled to a central portion (that is, a nose support area) of the eyeglass frame 600. For example, the frame of the optical path adjusting unit 200 includes a hole for receiving the virtual screen light input from the display unit 100, and a convergence lens module 220 is provided in the hole or adjacent area of the hole.

In some embodiments, the optical coupling unit 300 is coupled by inserting one side of the guide lens 310 into the frame of the optical path adjusting unit 200. That is, the frame of the optical path adjusting unit 200 includes one or more recesses, into which one side of the optical coupling unit 300 is inserted, and the virtual screen light may be provided through one side of the inserted optical coupling unit 300.

Further, in some embodiments, the optical system 10 for a head mount display according to an embodiment of the inventive concept further includes an adjustor. The adjustor sets up focuses corresponding to the eyes 500 of the wearer through adjustment of the optical path adjusting unit 200 (that is, an adjustment prism 210 or an optical path refraction module 230) or the coupling lens module 320. Because it is preferable that the angle of the optical coupling unit 300 be also adjusted based on the adjustment of the angle of the optical path adjusting unit 200, it is preferable that the angles of the optical coupling unit 300 and the optical path adjusting unit 200 be adjusted together in association with each other.

Further, in some embodiments, as illustrated in FIG. 10, the optical system 10 for a head mount display according to an embodiment of the inventive concept includes a display unit 100 and an optical path adjusting unit 200 in an interior space of the eyeglass, and includes an optical coupling unit 300 in the interior of the eyeglass lens. For example, the display unit 100 is provided in the interior of a leg of the eyeglass frame 600, and the optical path adjusting unit 200 is provided in the interior of the nose support of the eyeglass frame 600. Further, in some embodiments, a portion of the eyeglass lens having the optical coupling unit 300 therein is inserted into the nose support provided with an optical path adjusting unit to receive virtual screen light from the optical path adjusting unit.

The inventive concept has the following effects.

First, according to an embodiment of the optical system for a head mount display, the virtual screen of the display unit arranged on one side is delivered to an eye on an opposite side by converting a travel direction of the virtual screen that exits from the display with the optical path adjusting unit so that the volume of the optical system may be reduced as compared with the conventional optical system. Further, because the display unit provides virtual screen light towards the optical path adjusting unit that is close to the nose support at a location that is adjacent to the eyeglass lens, a front space for securing a space that provides virtual screen light is not necessary so that the front volume of the head mount display device may be reduced.

Second, because the display unit and the optical path adjusting unit are coupled to an inner surface of a leg of the eyeglass frame and a nose support area of the eyeglass frame, a configuration for implementing the optical system for a head mount display may not be exposed to the outside. Through this, because another person does not recognize that the user wears a head mount display or a glass type wearable device, the user may go about his or her daily lift while wearing a device.

Third, because the virtual screen light normally enters the eyeballs of the user from the direction of the field of view due to the optical coupling unit, the wearer may directly identify the virtual screen in a process of viewing an external reality screen. Through this, an augmented reality may be effectively implemented.

Fourth, because a manner of providing polarized light that is perpendicular to the left eye and the right eye or providing virtual screen light having a parallax may be applied while the volume of the optical system is minimized, a 3D augmented reality screen may be easily implemented.

Fifth, because a screen may be provided to both the optical coupling units by the display unit provided only on one side of a leg of the eyeglass frame, manufacturing costs may be reduced as compared with an existing manner of implementing binocular displays.

Sixth, components are not concentrated on one side of a glass type wearable device as in the existing optical system for a head mount display, the weight of the optical system is distributed so that the head mounted device may be stably worn. That is, because the optical path adjusting unit is arranged in the nose support area of the eyeglass frame and the display units or the optical coupling units may be arranged on opposite sides, the whole weight of the product may be distributed so that the optical system may have a stable center of weight.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. An optical system for a head mount display, comprising:
a display unit that is provided on an inner surface of a leg area of an eyeglass frame to provide virtual screen light;
an optical path adjusting unit that is provided on a nose support area of the eyeglass frame to convert a direction of the virtual screen light delivered from the display unit by refracting or reflecting the virtual screen light; and
an optical coupling unit that is provided in an interior of an eyeglass lens or at a location that is adjacent to the eyeglass lens to combine a virtual screen and a reality screen that is introduced from the outside and deliver the combined screen to the eyes of a wearer,
wherein the optical path adjusting unit inputs the virtual screen light, an optical path of which has been converted, to an interior of the optical coupling unit at an angle within a specific range.

2. The optical system of claim 1, wherein the display unit comprises:
a display panel that generates the virtual screen; and
a screen delivery lens that is spaced apart from the display panel by a specific gap to converge the virtual screen to the optical path adjusting unit.

3. The optical system of claim 1, wherein the optical path adjusting unit comprises:
a convergence lens module that is arranged to face the display unit to converge the virtual screen light input from the display unit to an interior of the optical path adjusting unit; and
an optical path refraction module that comprises one or more reflective surfaces to adjust a path of the virtual screen light.

4. The optical system of claim 3, wherein the optical path adjusting unit further comprises:
a divergence lens module that enlarges the virtual screen light, a path of which has been adjusted to the direction of the optical coupling unit by the optical path refraction module, at a specific magnification.

5. The optical system of claim 3, wherein the optical path refraction module comprises:
a path conversion reflective surface that converts the path of the virtual screen light input from the display unit by reflecting the virtual screen light; and
a divided reflective surface that reflects the virtual screen light, the path of which has been converted, and delivers the virtual screen light to the optical coupling unit that is unidirectional or bidirectional.

6. The optical system of claim 5, wherein the divided reflective surface comprises:
a first reflective surface that reflects the virtual screen light reflected by the path conversion reflective surface to an optical coupling unit for a left eye; and
a second reflective surface that reflects the virtual screen light reflected by the path conversion reflective surface to an optical coupling unit for a right eye, and
wherein the first reflective surface and the second reflective surface cross each other.

7. The optical system of claim 6, wherein the first reflective surface and the second reflective surface comprise different polarized coating layers, and different rays of polarized light of the optical coupling unit for a left eye and the optical coupling unit for a right eye are introduced into the first reflective surface and the second reflective surface.

8. The optical system of claim 6, wherein the first reflective surface and the second reflective surface comprise half mirrors and have the same reflective index such that the virtual screen light is uniformly introduced into the optical coupling unit for a left eye and the optical coupling unit for a right eye.

9. The optical system of claim 8, wherein the display unit alternately provides virtual screen light for a right eye and virtual screen light for a left eye, and
wherein the optical path adjusting unit further comprises:
a plurality of liquid crystal shutters that are provided in the directions of the optical coupling unit for a left eye and the optical coupling unit for a right eye and are opened and closed to correspond to a type of the virtual screen light provided from the display unit.

10. The optical system of claim 3, wherein the display units are arranged on inner surfaces of the leg areas of the eyeglass frame, respectively,
wherein the optical path adjusting unit further comprises:
an optical path adjusting unit for a left eye and an optical path adjusting unit for a right eye that have different optical path lengths, and
wherein the optical path adjusting unit for a left eye and the optical path adjusting unit for a right eye generate a parallax of the virtual screen between the eyes of the wearer.

11. The optical system of claim 1, wherein the optical coupling unit comprises:
a guide lens through which the virtual screen light input from the optical path adjusting unit travels; and
a coupling lens module that refracts or reflects the virtual screen light, which has passed through the guide lens, to provide the virtual screen light towards an eyeball of the wearer.

12. The optical system of claim 11, wherein the virtual screen light is input to an interior of the guide lens at an angle within a specific range and is input to the coupling lens module through total reflection in the guide lens.

13. The optical system of claim 11, wherein the coupling lens module comprises:
a plurality of polarized lenses that are formed of the same medium as that of the guide lens and have polarized inclined surfaces of a specific angle,
wherein the polarized inclined surfaces are coupled to the guide lens to face a side on which the virtual screen light is introduced, and
wherein the guide lens comprises:
a plurality of recesses corresponding to the shapes of the plurality of polarized lenses, respectively.

14. The optical system of claim 13, wherein the polarized inclined surfaces are spaced apart from each other at a specific gap.

15. The optical system of claim 13, wherein the virtual screen light at various locations is input to an eyeball of the wearer at the same brightness by differently applying the reflective indexes of the polarized inclined surfaces

16. The optical system of claim 1, wherein the display unit, the optical path adjusting unit, and the optical coupling unit are manufactured as modules that are separated from or coupled to the eyeglass frame.

17. The optical system of claim 16, wherein the optical path adjusting unit comprises:
at least one recess, into which one side of the optical coupling unit is inserted, and
wherein the virtual screen light is provided through one side of the inserted optical coupling unit.
